(19) United States
(12) Patent Application Publication
(10) Pub. No.: US 2023/0229017 A1
(43) Pub. Date: Jul. 20, 2023

(54) EYEWEAR WITH IMPROVED NOSE PAD ASSEMBLIES

(71) Applicant: FGX INTERNATIONAL INC., Smithfield, RI (US)

(72) Inventor: Roy Kenneth Williams, Vancouver (CA)

(21) Appl. No.: 17/576,715

(22) Filed: Jan. 14, 2022

(51) Int. Cl. G02C 5/12

(52) U.S. Cl. CPC G02C 5/12

(57) ABSTRACT

The present invention is directed toward eyewear having an improved nose pad assembly which reduces visual obstructions and provides a greater range of accommodation for various facial geometries. In one embodiment, the improved nose pad assembly is disposed on a bottom portion of the frame, below the wearer's eyes, and extends upwardly and inwardly toward the wearer's nose.

### BACKGROUND OF THE INVENTION

### Field of the Invention

The invention is related to improvements in the field of eyewear and, in particular, improved nose pad assemblies for eyewear that accommodate a wide variety of facial contours and reduce visual obstructions.

### Description of the Related Art

Traditional eyewear construction includes a pair of nose pad assemblies intended to sit on the bridge of the wearer's nose. In the most basic construction, two pads are molded into the eyewear frame in between the lenses, relatively high up in the wearer's field of view. This not only causes a visual obstruction, but requires a certain range facial geometry in order to permit the eyewear to sit properly on the wearer's face, which is generally a minimum and maximum nose bridge angle or nose width. The appropriate facial geometry will depend upon the distance between the lenses, among other things.

Some efforts have been made to reduce the visual obstruction caused by nose pads, especially in the field of sporting eyewear. A typical design in this category includes a single lens spanning the wearer's field of view having a triangular cutout in the center. A rubberized, triangular nose pad is inserted into the cutout in order to provide grip on the wearer's nose. However, this style still does not address the relatively narrow range of facial geometries that can be accommodated by the triangular cutout. This is evidenced by the fact that certain manufacturers provide a range of styles in multiple fitments, which are sometimes noted to be “global” or “asian” fit given that those of Asian heritage tend to have higher cheekbones and narrower nose bridges than those of other ethnic backgrounds. This is not the only issue facing eyewear designers, as a truly universal fit should also accommodate those with disabilities, injuries, birth defects, and the like.

The traditional design for an adjustable nose pad includes placing the pad on descending wires placed between the lenses, relatively high up in the wearer's field of view. The range of adjustment is quite limited, however, and is more suited to fine adjustments of the position of the eyewear on the wearer's face, and not robust enough to accommodate eyewear that would otherwise not be suitable for a wearer's facial geometry. The design does not truly accommodate a wide range of facial geometries. Moreover, the design does nothing to eliminate or reduce visual obstructions.

The present invention addresses these and other problems remaining in the art.

### SUMMARY OF THE INVENTION

The present invention is directed to eyewear having improved construction and design of nose pad assemblies which accommodate a wide variety of facial geometries and reduce visual obstructions. In one embodiment, the inventive nose pad assemblies are disposed on a bottom portion of the eyewear and protrude upwardly and inwardly toward the wearer's face. This inventive arrangement serves to reduce visual obstructions because the entire nose pad assembly can be disposed below the wearer's eye and/or line of sight, as opposed to traditional, descending wire nose pad assemblies which are higher up between the lenses and almost directly in the wearer's line of sight. Moreover, traditional descending wire nose pad assemblies also require a minimum angle in the nose bridge or else a minimum width of the nose bridge in order sit properly on the wearer's face. The inventive arrangement can accommodate any nose dimension or else can even sit on the wearer's cheeks below the eyes if the wearer does not have a sufficiently defined nose bridge.

In a preferred embodiment the frame of the inventive eyewear includes a top portion and a bottom portion which supports lenses, or a single large lens, therein. In a most preferred embodiment, the bottom portion may include a left lens support, a right lens support, and a gap therebetween, but the principles of the present invention can be implemented in a frame having a single bottom portion spanning the frame. The inventive nose pad assemblies may be disposed on each of the left and right lens supports and extend into the gap. In a most preferred embodiment, the nose pad assemblies extend from an end of each of the left and right lens supports.

In an adjustable embodiment of the present invention, the nose pad assemblies can include a core surrounded by a pad. The core may be selected from a material that is, and dimensioned to be, plastically deformable by hand, without the need for tools, such that a wearer can position the tip of the nose pad by manipulating it with his or her fingers. The material of the core should also be selected to provide sufficient durability and strength such that it does not become brittle or otherwise fatigue with repeated adjustments. A wide variety of such materials are presently known and employed in traditional nose pad assemblies. In a most preferred embodiment, the core is made from SAE 304 stainless steel and is configured as a thin ribbon or wafer to encourage bending in at least one direction. Additionally, the core may be co-molded into the bottom portion of the frame with a portion protruding therefrom, i.e., in embodiments where the frame is injection molded, the core may be first inserted into the mold, and the molten frame material injected around the core.

Additionally in a preferred embodiment the pad may be made of a material that is comfortable and provides sufficient grip on skin, particularly when the wearer is perspiring or in wet conditions. The class of polymers known as thermoplastic rubber (TPR) makes a suitable material choice for a preferred embodiment, given that the polymers in that class tend to have the thermoplasticity of a traditional plastic, which facilitates manufacturing, but have the toughness and durability of a traditional rubber. Additionally, many TPR materials have a soft, rubbery texture which enhances comfort and grip on the wearer. In adjustable embodiment of the present invention, the core should be stiffer than the pad, such that the pad does not interfere when the core is adjusted. In a most preferred embodiment the pad is configured as a finger extending from an end of the lens support upward and inward toward the wearer. The finger may also have a tapered configuration toward the distal end to enhance comfort and reduce visual obstruction.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front perspective view of eyewear in accordance with one embodiment of the present invention wherein the eyewear has no lens to facilitate disclosure of the nose pads.

FIG. 2 is a front perspective view of the embodiment of FIG. 1.

FIG. 3 is a side perspective view of the embodiment of FIG. 1.

FIG. 4 is a top view of eyewear in accordance with one embodiment of the present invention wherein the eyewear has no lens or pad to facilitate disclosure of the core.

FIG. 5 is a front view of the embodiment of FIG. 4.

FIG. 6 is a side view of the embodiment of FIG. 4.

Like reference numerals refer to like parts throughout the several views of the drawings.

### DETAILED DESCRIPTION OF THE PREFERRED EMBODIMENT

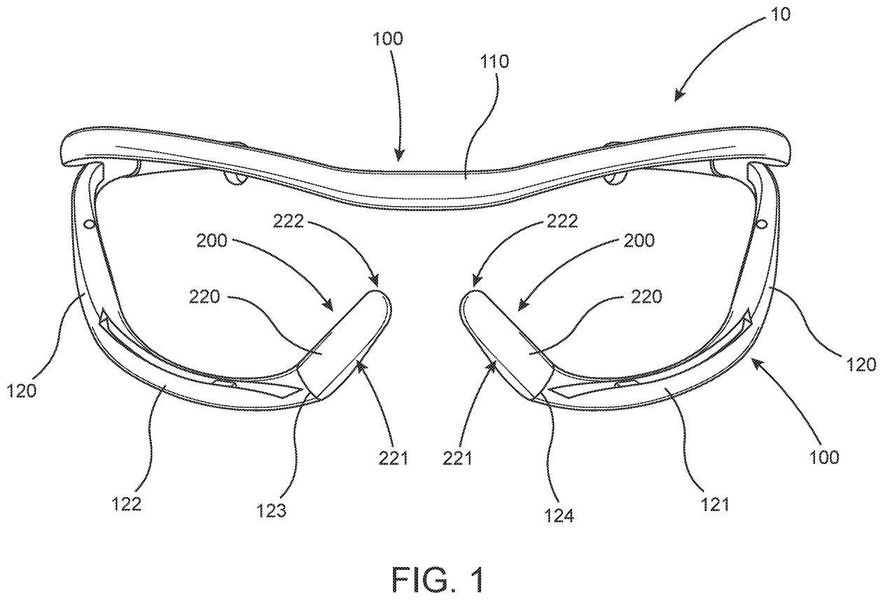

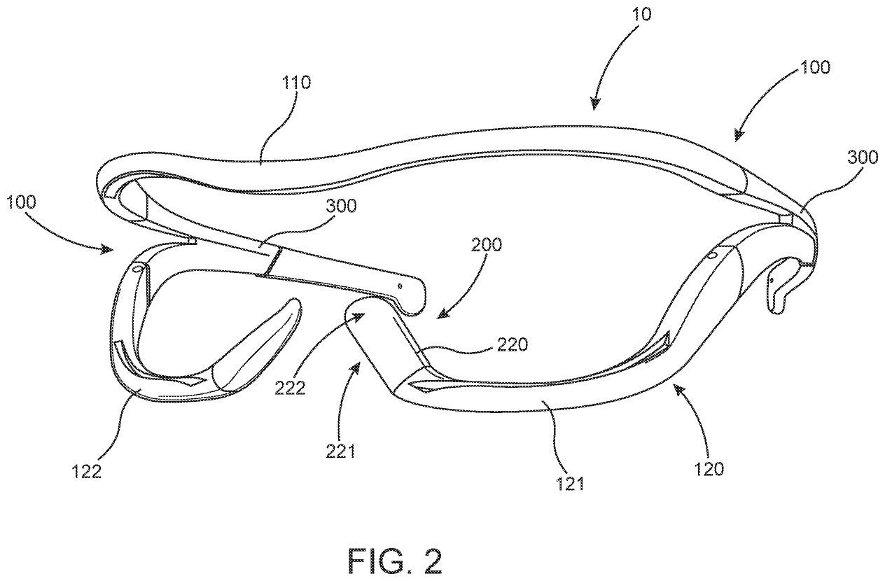

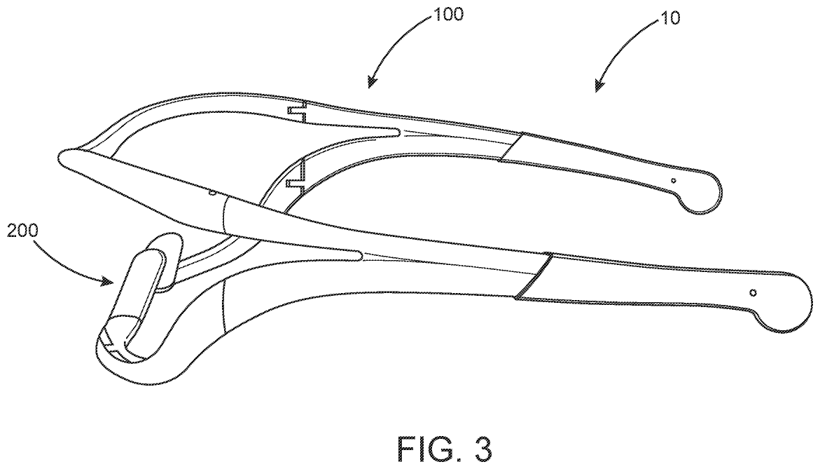

With reference to FIGS. 1-3, eyewear 10 in accordance with one embodiment of the present invention is depicted having the lens or lenses removed to facilitate disclosure of the nose pad assembly 200. The eyewear 10 includes a frame 100 comprised of a pair of temple bars 300, a top portion 110, and a bottom portion 120. In the depicted embodiment, the bottom portion 120 is separated into a left lens support 121 and a right lens support 122 with a gap therebetween. The nose pad assemblies 200 protrude from the ends 123, 124 of each lens support 121, 122. Each nose pad assembly includes a core (depicted in later figures) and a pad 220. The pad 220 can comprise virtually any shape that is desired, but in the depicted embodiment, the pad 220 is configured in an ergonomic shape, which will be referred to as a finger 221, and which is designed to sit comfortably on the wearer's face and reduce visual obstructions. As can be seen the finger 221 substantially corresponds to the shape of the bottom portion 120 at each end 123, 124 thereof and tapers at the distal end 222 of the finger 221.

The pad 220 may be made of any suitable material. However, it will be appreciated that certain materials may be more desirable. For example, for eyewear that is more sport-oriented, it may be desirable to select a material that provides sufficient grip when the wearer is perspiring. For ease of manufacturing, it may also be desirable to form the pad 220 integrally with the bottom portion 120 of the frame 100. However, it will also be appreciated that this will limit adjustability of the nose pad assembly 200 as frame materials tend to be rigid plastic which are not plastically deformable. In adjustable embodiments of the present invention, a pliable material is desired which can conform when the core is bent by the wearer and will not interfere with the bending. By way of example, rubbers and thermoplastic rubbers provide suitable pliability.

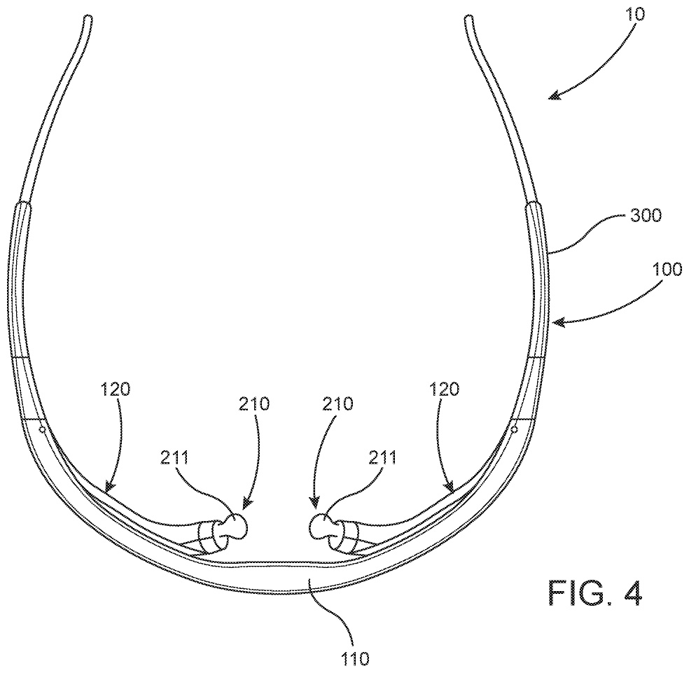

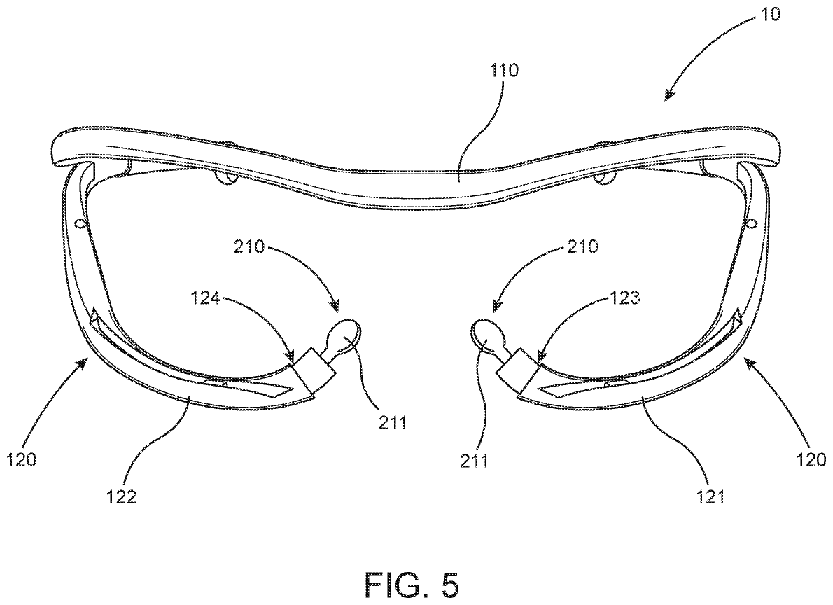

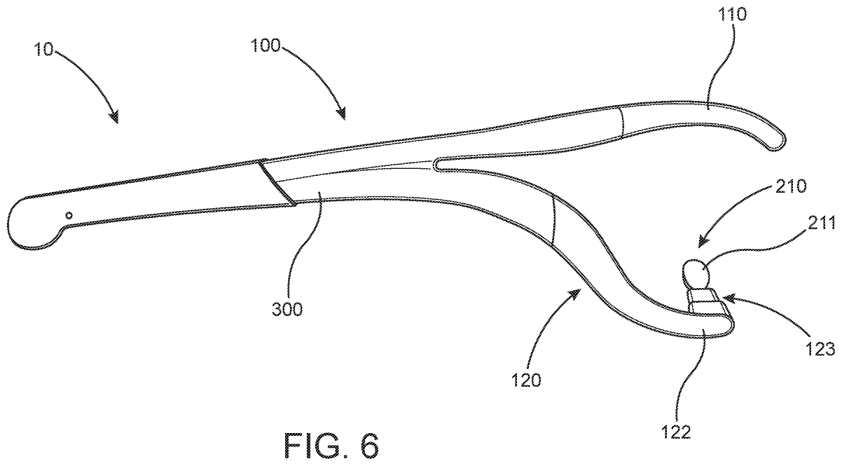

Now with reference to FIGS. 4-6, the inventive eyewear 10 is depicted having no lens nor pads, such that the core 210 can be easily seen. As such, in a preferred embodiment, a pair of cores 210 project from then ends 123, 124 of the left and right lens supports 121, 122. In a preferred embodiment, a portion of the core 210 is embedded within the left and right lens supports 121, 122 to provide support for the plastically deformable member 211 portion of the core 210 that protrudes from the ends 123, 124. In the depicted embodiment, the core 210 is configured as a wafer—that is to say that the ratio of the core's 210 thickness to its width is substantially lower than one. In this regard, the core 210 can be easily bent in at least one direction, but resists bending in other directions. Alternatively, if a wider range of adjustment is desired, the core 210 can be configured in another shape, such as a cylinder, which would facilitate bending in any direction with the same amount of force applied. Other cross sections, such as triangular or rectangular, can be implemented to provide more range of adjustment than a wafer, but less than a cylinder.

In adjustable embodiments of the present invention, care must be taken when specifying dimensions of the core 210 in light of material selection. In at least one embodiment, the plastically deformable member 211 should reach plastic deformation relatively early in the strain curve in order to facilitate minute adjustments of the nose pad assembly 200. If for example, a minute adjustment is desired but the applied force is only sufficient to reach elastic deformation within the core 210, then the core 210 will return to its original position, which would be undesirable. On the other hand, and for different use cases, that behavior may not be desirable given that undesired adjustments may take place if the core 210 is bumped or crushed inadvertently. In such a use case, a higher resilience is desired where the core 210 would reach plastic deformation much later in the strain curve to help ensure that the core 210 retains its initial adjustment unless an intentional adjustment is made. Finally, the expected life span of the eyewear 10 should be considered in fatigue analysis of the core 210. Care should be taken that the core 210 does not fail prematurely.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. Eyewear comprising:
a frame including a top portion and a bottom portion;
a pair of nose pad assemblies projecting from said bottom portion of said frame.

2. The eyewear as recited in claim 1 wherein each of said pair of nose pad assemblies is comprised of a core and a pad.

3. The eyewear as recited in claim 2 wherein said pad surrounds said core.

4. The eyewear as recited in claim 2 wherein said pad is configured as a finger.

5. The eyewear as recited in claim 4 wherein said finger tapers toward a distal end of said pad.

6. The eyewear as recited in claim 2 wherein said core is made from a plastically deformable member.

7. The eyewear as recited in claim 6 wherein said core is comprised of grade 304 stainless steel;
said core being of sufficient thinness to permit said core to be deformed by hand.

8. The eyewear as recited in claim 6 wherein said core is dimensioned and configured as a wafer, thereby rendering it resistant to bending in at least one direction.

9. The eyewear as recited in claim 1 wherein each of said pair of nose pad assemblies is configured to generally protrude upwardly and inwardly toward a wearer's nose from said bottom portion of said frame.

10. The eyewear as recited in claim 9 wherein each of said pair of nose pad assemblies is adjustable via deformation of said nose pad assemblies away from said generally upward and inward direction.

11. Eyewear comprising:
a frame including a top portion and a bottom portion, said bottom portion including at least a left lens support and a right lens support;
a pair of nose pad assemblies, one of said pair of nose pad assemblies each extending inwardly from and end of said left lens support and inwardly from an end of said right lens support.

12. The eyewear as recited in claim 11 wherein said nose pad assemblies each comprise a core and a pad.

13. The eyewear as recited in claim 11 wherein said core is at least partially co-molded into said bottom portion of said frame.

14. The eyewear as recited in claim 13 wherein said core includes a plastically deformable member extending from said bottom portion of said frame into said pad.

15. Eyewear comprising:
a frame including a top portion and a bottom portion;
a pair of nose pad assemblies projecting from said bottom portion of said frame;
said nose pad assemblies configured and dimensioned to extend toward a wearer's face from below the wearer's eyes.

16. The eyewear as recited in claim 15 wherein said bottom portion is separated into a left lens support and a right lens support having a gap therebetween.

17. The eyewear as recited in claim 16 wherein said nose pad assemblies extend at least partially into said gap between said left and right lens supports.
